(19) United States
(12) Patent Application Publication
(10) Pub. No.: US 2001/0012050 A1
(43) Pub. Date: Aug. 9, 2001

(54) VIDEOCONFERENCING ARRANGEMENT USING A CAMERA DISPLAY SCREEN

(75) Inventors: SAMUEL T. WANG, SAN JOSE, CA (US); DOUGLAS JOHN BAILEY, SAN JOSE, CA (US); JOSEPH L. PARKINSON, BOISE, ID (US)

Correspondence Address: Robert J. Crawford, CRAWFORD PLLC, 1270 Northland Drive, Suite 390, St. Paul, MN, 55120, US

(73) Assignee: NETERGY NETWORKS, INC.

(21) Appl. No.: 09/021,746

(22) Filed: Feb. 11, 1998

Related U.S. Application Data
(63) Continuation-in-part of application No. 08/941,975, filed on Oct. 1, 1997.

(51) Int. Cl. H04N 7/14

(52) U.S. Cl. 348/14.01; 348/14.04; 348/14.07

(57) ABSTRACT

A videoconferencing system uses a modular terminal that includes a conventional video camera or digital still camera coupled to the input port of the videocommunicator, such as a set top box. The camera includes a video input port and a display screen, and the videocommunicator is coupled to the video input port of the camera, whereby videoconference images are displayed on the camera display screen.

### RELATED APPLICATIONS

The present application is a continuation application of U.S. patent application No. 08/941,975, filed on Oct. 1, 1997, and entitled, “VIDEOCONFERENCING ARRANGEMENT HAVING MULTI-PURPOSE DIGITAL STILL CAMERA.” The present application is related to and fully incorporates the teachings of U.S. patent application No. 08/934,184 (Docket No. 11611.43-US-01), filed on Sep. 19, 1997, and entitled “VIDEO TTY DEVICE AND METHOD FOR VIDEOCONFERENCING.” Both applications are assigned to the assignee of the present invention.

1. Field of the Invention

The present invention relates generally to communication systems and, more particularly, to video communication systems and arrangements.

2. Background of the Invention

Video communication systems have become increasingly popular. Videoconferencing, for example, is becoming more common in both business and residential applications. Videoconferencing permits audio as well as visual live communication between two remotely located terminals communicating over a single channel. Videoconferencing has had limited success due to, for example, unavailability of a common network interface, overly complex controls, poor video quality, limited functionality, inconvenience, and high cost. Improving video quality and functionality while simultaneously decreasing costs has proven to be a seemingly unobtainable goal. For this reason, there have been opposing pressures to develop certain more expensive systems having increased video quality and functionality and certain other systems that forego the convenience and quality criteria for the sake of reducing costs.

One recent approach, that attempts to addresses some of the above-mentioned issues, uses a digital video camera coupled to the input port of a PC which is programmed to provide videoconferencing over a communications channel, such as the Internet. This approach is useful for applications where a PC is readily available and the user is fully familiar with downloading the software and using the PC to control the videoconferencing. However, the approach is disadvantageous for environments directed to those who are not as computer literate or not interested in using a computer for videoconferencing.

The above types of implementations are, of course, a compromise. Ideally, videoconferencing systems and equipment can be provided for both business and residential applications at reasonable costs and without sacrificing video quality, functionality, or convenience. The present invention is directed to accommodating this ideal.

### SUMMARY OF THE INVENTION

The present invention is directed to methods and arrangements for use in videoconferencing. According to one embodiment of the present invention, an arrangement for a videoconferencing system comprises: a camera having a video input port and a video output port and including a display screen, wherein the camera is arranged to output video signals, received via the input port, to the display screen and output via the output port video signals representing a videoconference scene captured by the camera; and a set-top box having a video input port and a video output port coupled to the video output port and the video input port of the camera, respectively, the set-top box further having a communication port and arranged to transmit videoconferencing data from the first site to the second site and receive videoconferencing data from the second site, whereby videoconferencing video signals are viewable on the display screen of the camera.

According to another embodiment, the present invention provides a method of videoconferening, comprising the steps of: coupling the video output port of the camera to the video input port of the set-top box; coupling the video output port of the set-top box to the video-input port of the camera, whereby videoconferencing video signals generated by the set-top box are viewable on the display screen of the camera; coupling the communication port of the set-top box to a communication channel; and establishing a videoconference between the first and second site using the set-top box.

The above summary of the invention is not intended to describe each disclosed embodiment of the present invention. An overview of other example aspects and implementations will be recognizable from the figures and from the detailed description that follows.

### BRIEF DESCRIPTION OF THE DRAWINGS

Other aspects and advantages of the present invention will become apparent upon reading the following detailed description and upon reference to the drawings in which:

FIG. 1 is a block diagram of a videoconferencing system, according to a particular application of the present invention; and

FIG. 2 is a block diagram of a modular videoconferencing arrangement, illustrating an example implementation of one terminal shown in the system of FIG. 1, according to another particular application of the present invention.

While the invention is amenable to various modifications and alternative forms, specifics thereof have been shown by way of example in the drawings and will be described in detail. It should be understood, however, that the intention is not to limit the invention to the particular embodiments described. On the contrary, the intention is cover all modifications, equivalents and alternatives falling within the spirit and scope of the invention as defined by the appended claims.

### DETAILED DESCRIPTION OF THE PREFERRED EMBODIMENT

While the present invention may be useful in a variety of applications, the present invention has been found to be particularly advantageous in videoconferencing applications requiring or benefiting from real time and/or still frame visual communications. One aspect of the present invention is directed to modular, low-cost videoconferencing providing real time visual communication using the display screen of a camera for display of the videoconference. An appreciation of various aspects of the invention is best gained through a discussion of various application examples operating in such an environment.

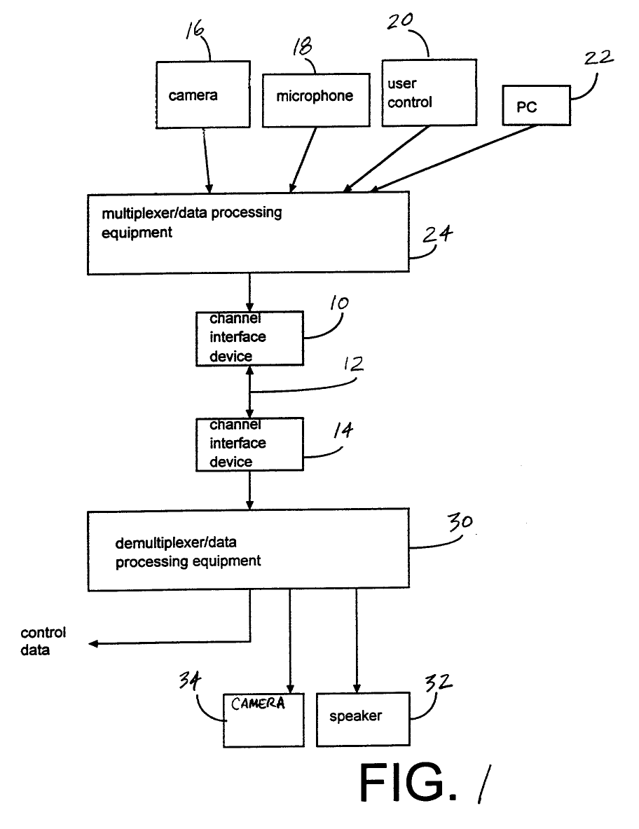

Turning now to the drawings, FIG. 1 illustrates a data processing system for a videoconferencing application. The system includes data sending equipment depicted above a communication channel 12 of FIG. 1 and data receiving equipment depicted below the communication channel 12. While the sending and receiving of such data is often reciprocal in many data processing applications of this type as with the instant videoconferencing illustration, the configuration illustrated in FIG. 1 is simplified in this regard to facilitate the discussion.

At the sending end of the system of FIG. 1, a transmitting channel interface device 10 is used to send processed data over the communication channel 12 to a receiving channel interface device 14. The data that is presented to the channel interface device 10 is collected from various types of data sources including, for example, a camera 16, a microphone 18, a user control device 20, and a conventional personal computer 22. The data sources typically use buffers to store the data to be collected. The data collected from each of these data sources is received by multiplexer/data processing equipment (MDPE) 24. The MDPE 24 collects and formats the data collected from each of the input sources for transmission over the channel 12.

At the lower end of the system of FIG. 1, the formatted data communicated over the channel 12 is received by the channel interface device 14, which then presents the received data to demultiplexer/data processing equipment (DDPE) 30. The DDPE 30 is set up to sort out the formatted data received over the channel 12 according to instructions previously sent by the MDPE 24. The demultiplexed data is then presented to the appropriate output source equipment, including audio data to a speaker 32, video data to a camera 34, and control data to external equipment for subsequent processing.

In a departure from conventional videoconferencing arrangements, the embodiment of FIG. 1 does not include a monitor for displaying the video conference. Instead, camera 34, for example, is a digital still camera or a video camera having a display screen and a video input port. DDPE 30 is coupled to a video input port of camera 34, whereby a video conference is viewed on the display screen of camera 34.

The MDPE 24 formats the collected data for transmission using any of a variety of modes of operation or capabilities. For example, audio data may be formatted using a capability that supports the ITU-T G.71 1, G.723, or G.728 standard.

For further information regarding use of a multiplexer to increase use of the transmission channel for video data, reference may be made to U.S. patent application No. 08/815,966, filed on Mar. 13, 1997 (Atty. Docket No. 11611.15US01), incorporated herein by reference.

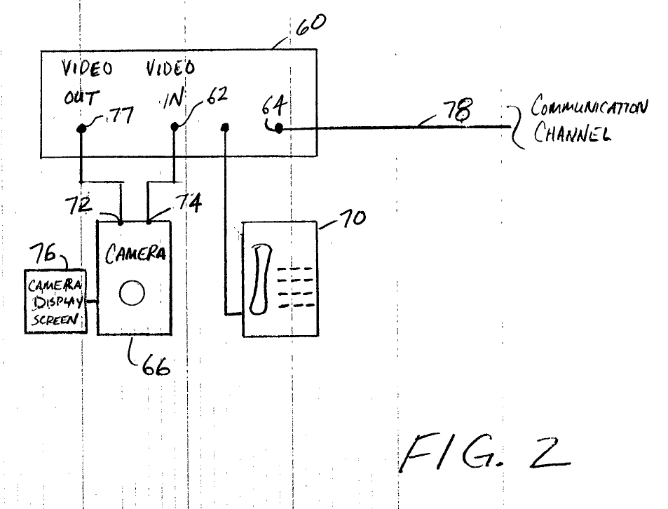

FIG. 2 illustrates a videocommunicator 60 including an analog-to-digital converter for converting analog video signals presented at input port 62 to digital video data. Videocommunicator also includes a digital signal processor for processing digital video data and for presenting encoded video data to an output port 64. The encoding provided by the videocommunicator 60 includes video data compression and, as the application may require, video data decompression functionality. The arrangement further includes a camera 66, and a conventional touch-tone telephone 70.

The camera 66, as exemplified in FIG. 2, is a commercially available video camera, such as the Sony CCD-TRV101, or alternatively a digital still frame camera. Such example cameras, as well as other commercially available cameras, include a video input port 72, a video output port 74, and a display screen 76 for viewing images. The images in display screen 76 may be those generated from camera 66, or from an external source. In the present embodiment, the images displayed on display screen 76 are provided by videocommunicator 60 as input to camera 66. The video input port 72 of the camera 66 is coupled to the video output port 77 of videocommunicator 60, and the video output port 74 of the camera is coupled to the video input port 62 of the videocommunicator. Thus, camera 66 serves the dual purpose of capturing a videoconference scene for transmission by videocommunicator 60 to another videocommunicator, and displaying videoconference images as presented by videocommunicator 60. The video signal provided from the camera 66 to the video input port 62 is used by the videocommunicator 60 to present an image or selected images to display screen 76 via camera 66, as well as over a communications channel 78 for processing or remote display.

A characteristic common to the aforementioned cameras is that the display screen 76 may be articulated such that it is viewable by the videoconference participant concurrent with camera 66 capturing the image of the participant. The articulation of display screen 76 is achieved, for example, with a swivel screen mounted to camera 66 as with the Sony CCD-TRV101 video camera, or with a camera portion that swivels on top of a base display screen. Another camera can have a camera portion that is detachable from the display screen portion in yet another example arrangement.

Touch-tone telephone 70, as shown in the example embodiment of FIG. 2, is a conventional telephone that is used in this arrangement for conventional telephony applications, as well as to provide an audio interface for videoconferencing using the arrangement of FIG. 2. In addition, the keypad of the telephone 70 is used to provide user control for the videocommunicator 60 including, for example, electronic pan/tilt/zoom function control, split-screen control and image size control to the remote and local displays. For further information concerning an example method for implementing pan/tilt/zoom function control, reference may be made to U.S. patent application Serial No. 08/861,619 (Docket No. 11611.47-US-01), entitled “Arrangement for Controlling the View Area of a Video Conferencing Device and Method Therefor” (incorporated herein by reference). Other control features and functions may be implemented using conventional keypad control operations and will not be further discussed in detail.

There are many specific applications for this above-described embodiment. Using commercially available and relatively inexpensive components, such as the camera 66 and a telephone, the videocommunicator can be used as a central controller providing videoconferencing signal coordination and processing in a relatively inexpensive, modular form. Further, a single housing can be used to integrate both videoconferencing and conventional digital still camera functionality.

It will be understood that the processor-based circuit, or videocommunicator shown above in FIG. 2 can be implemented using any of a variety of processor arrangements, including the arrangement of the referenced patent applications and those disclosed in U.S. patent application Nos. 08/692,993 and 08/658917, respectively entitled and relating to issued patents also entitled “Programmable Architecture and Methods for Motion Estimation” (U.S. Pat. No. 5,594,813) and “Video Compression and Decompression Processing and Processors” (Patent No.5,379,351). These applications and issued patents are, incorporated herein by reference. As other example implementations, the videocommunicator of FIG. 2 is configured as a ViaTV product available from 8×8, Inc. and as a set-top box with the features of a VC55-type ViaTV Phone arrangement and with a keypad control console, such as a keypad, coupled into the MDPE 24 using conventional wiring or an infrared transmitter/receiver arrangement. The features of the VC55 are described in U.S. patent Application No. ___ ___, filed on Jan. 9, 1998, entitled “VIDEOCOMMUNICATING APPARATUS AND METHOD THEREFOR,” (Docket No. 11611.51-US-01), which is incorporated herein by reference.

The various embodiments described above are provided by way of illustration only and are not intended to limit the invention. Those skilled in the art will readily recognize various modifications and changes that may be made to the present invention without strictly following the example embodiments and applications illustrated and described herein. The scope of the present invention is set forth in the following claims.

We claim:

1. A videoconferencing arrangement for use at a first site in a videoconference between the first site and a second site, comprising:
a camera having a video input port and a video output port and including a display screen, wherein the camera is arranged to output video signals, received via the input port, to the display screen and output via the output port video signals representing a videoconference scene captured by the camera; and
a video processor unit having a video input port and a video output port coupled to the video output port and the video input port of the camera, respectively, the video processor unit further having a communication port and arranged to transmit videoconferencing data from the first site to the second site and receive videoconferencing data from the second site, whereby videoconferencing video signals are viewable on the display screen of the camera.

2. The arrangement of claim 1, further comprising:
the video processor unit having first and second telephone ports, and arranged to, via the second telephone port, output video signals from the first site and input and receive video signals from the second site; and
a telephone coupled to the first telephone port and arranged to provide user-input control signals to the set-top box.

3. The arrangement of claim 1, where in the camera includes a body, and the display screen is a swivel screen mounted to the body, whereby the cam era is positionable to capture a scene at the first site, and an image of the scene is viewable on the display screen from a location within the scene.

4. The arrangement of claim 3, wherein the camera is a video camera.

5. The arrangement of claim 3, wherein the camera is a digital still camera.

6. The arrangement of claim 1, wherein the camera includes an image-capture portion and a display screen portion, wherein the image-capture portion is pivotably mounted to the display screen portion.

7. The arrangement of claim 1, wherein the camera includes an image-capture portion and a display screen portion, wherein the image capture portion is coupled to the display screen portion with a cable.

8. The arrangement of claim 1, wherein the video processor unit has a telephone port and is arranged to receive user control signals via the telephone port;

9. The arrangement of claim 8, further comprising a telephone coupled to the telephone port of the video processor unit.

10. The arrangement of claim 9, wherein the communication port is a telephone port.

11. The arrangement of claim 9, wherein the communication port is an ethernet port.

12. The method of claim 1, wherein the video processor unit and the camera are enclosed in a single housing and are arranged to capture, store and display digital still images.

13. A method of videoconferencing between a first site and a second site using a set-top box and a camera at the first site, the camera having a video input port, a video output port, and a display screen, the set-top box having a video input port, a video output port, and a communication port, comprising the steps of:
coupling the video output port of the camera to the video input port of the set-top box;
coupling the video output port of the set-top box to the video-input port of the camera, whereby videoconferencing video signals generated by the set-top box are viewable on the display screen of the camera;
coupling the communication port of the set-top box to a communication channel; and
establishing a videoconference between the first and second site using the set-top box.

14. The method of claim 13, further comprising the step of positioning the display screen of the camera so that videoconferencing video signals displayed thereon are viewable from a location within a scene captures by the camera.
